(19) United States
(12) Patent Application Publication
(10) Pub. No.: US 2007/0147376 A1
(43) Pub. Date: Jun. 28, 2007

(54) Router-assisted DDoS protection by tunneling replicas

(75) Inventors: Radia J. Perlman, Sammamish, WA (US); Hilarie Orman, Woodland Hills, UT (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/315,831

(22) Filed: Dec. 22, 2005

(51) Int. Cl. H04L 12/56

(52) U.S. Cl. 370/392; 370/401

(57) ABSTRACT

A method for protecting a victim includes locating at least one router, providing a set of addresses associated with at least one replica and a victim to each of the at least one router, intercepting a request packet sent from a requesting source to the victim by one of the at least one router, directing the request packet to the at least one replica, and creating a response packet specifying the victim as a response source and the requesting source as a response destination.

### BACKGROUND

Traffic on a network is often routed from one device to another in the form of packets. For example, devices such as computers connected to the Internet typically use Internet Protocol (“IP”) packets to communicate. These IP packets are transferred from one computer to another, typically through networking devices such as routers, using the IP addresses of the computers to represent a source and a destination of the IP packet.

A device connected to a network occasionally receives a volume of traffic higher than it is capable of effectively handling. For example, a server for a popular web site may become inundated with requests from computers that try to access the web site. In other instances, a malicious requesting source (such as a computer controlled by a hacker on the Internet) may use a denial-of service attack (“DoS attack”) to consume the computational resources and/or the bandwidth of a victim system. Similarly, in a distributed denial-of service attack (“DDOS attack”), multiple hosts may be used to flood a victim system with request packets.

A number of solutions exist to deal with DoS and DDoS attacks. For example, servers may be replicated with multiple domain names, using different names for each server. In this case, if a user knows the name of each replicated server, the user may try the different names until one of the names allows access to the desired network resource. Another method involves creating a larger number of replicas of a given system, and using the IP addresses of the replicas loaded into a DNS, such that traffic from clients trying to access the system by its name is split after the replicas are created.

Infrastructure provided by a company designated for internet caching may also alleviate a high volume of traffic directed to a single computer. For example, a company may request the services of a corporation such as Akamai Technologies, Inc. (Cambridge, Mass.), to post the content of the company's server on a large number of machines across the Internet. The web addresses of the company are changed such that the name is resolved by an Akamai domain name system (“DNS”) server. The Akamai DNS server attempts to return an IP address based on the current load and location of the client requesting the IP address from the name.

Another solution is to use a load balancer. For example, one type of load balancer acts as a gateway to a large number of replicas of a single network device (e.g., a server). In this case, a user accesses the network device or any one of the seemingly identical replicas through the network address of the load balancer, which is the gateway to the network device and the replicas. The load balancer forwards an access request from the user to the network device or a replica as it determines appropriate.

### SUMMARY

In general, in one aspect, the invention relates to a method for protecting a victim, including locating at least one router, providing a set of addresses associated with at least one replica and a victim to each of the at least one router, intercepting a request packet sent from a requesting source to the victim by one of the at least one router, directing the request packet to the at least one replica, and creating a response packet specifying the victim as a response source and the requesting source as a response destination.

In general, in one aspect, the invention relates to a network system, including at least one requesting source configured to send a request packet to a victim, at least one router, and at least one replica associated with the victim, where the at least one replica is configured to receive the request packet and to redirect the request packet sent from the at least one requesting source intended for the victim, and where the at least one router is configured to direct the request packet to the at least one replica.

In general, in one aspect, the invention relates to a computer system for protecting a victim, including a processor, a memory, a storage device, and software instructions stored in the memory for enabling the computer system under control of the processor to: locate at least one router on a path between the victim and a requesting source, provide a set of addresses associated with at least one replica and the victim to each of the at least one router, intercept a request packet sent from the requesting source to the victim by one of the at least one router, direct the request packet to the at least one replica, and create a response packet specifying the victim as a response source and the requesting source as a response destination.

Other aspects of the invention will be apparent from the following description and the appended claims.

### BRIEF DESCRIPTION OF DRAWINGS

FIG. 1 shows a block diagram of a network system in accordance with an embodiment of the invention.

FIG. 2 shows a flowchart for informing a router of elements in a network system in accordance with an embodiment of the invention.

FIG. 3 shows a flowchart describing routing one or more network packets in accordance with an embodiment of the invention.

FIG. 4A shows a tunneled request packet in accordance with an embodiment of the invention.

FIG. 4B shows a tunneled response packet in accordance with an embodiment of the invention.

FIG. 5 shows a block diagram of an example of a network system in accordance with an embodiment of the invention.

FIG. 6 shows a computer system in accordance with an embodiment of the invention.

### DETAILED DESCRIPTION

Exemplary embodiments of the invention will be described with reference to the accompanying drawings. Like items in the drawings are shown with the same reference numbers.

In the following description, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method for protecting a computer in a network. Further, embodiments of the invention relate to protecting a computer in a network from a large number of requests, such as a number of requests experienced during a distributed denial of service attack.

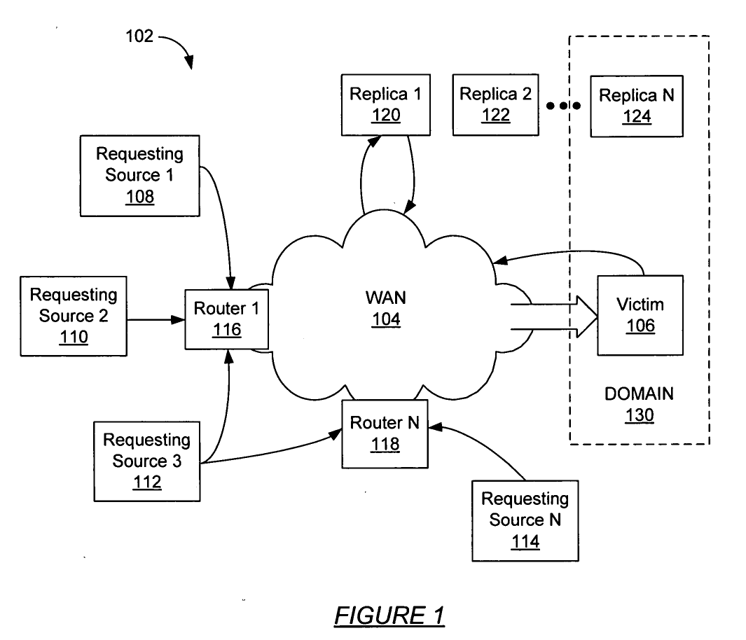

FIG. 1 shows a network system (102) in accordance with an embodiment of the invention. The network system includes a wide-area network (WAN) (104), such as the Internet. Associated with the WAN (104) are a victim (106) and any number of requesting sources (e.g., Requesting Source 1(108), Requesting Source 2 (110), Requesting Source 3 (112), Requesting Source N (114)). At least one router (e.g., Router 1 (110), Router N (118)) is located between the requesting sources (108, 110, 112, 114) and the victim (106). Additionally, one or more replicas (e.g., Replica 1 (120), Replica 2 (122), Replica N (124)) are connected to the WAN (104), and are associated with the victim (106).

One skilled in the art will appreciate that the WAN (104) may be any appropriate network. In one embodiment of the invention, the WAN (104) is the Internet. Thus, any number of connected routers (e.g., Router 1 (116), Router N (118)) may connect one or more requesting sources (e.g., Requesting Source 1(108), Requesting Source 2 (110), Requesting Source 3 (112), Requesting Source N (114)) to the Internet. Replica(s) (e.g., Replica 1 (120), Replica 2 (122), Replica (N) 124)) and the victim (106) may likewise be connected to the WAN (104) by a router (e.g., Router 1 (116), Router N (118)).

The requesting source(s) (108, 110, 112, 114) directs requests to the victim (106) via the WAN (104). The requesting source(s) may be a single computing device or system with a processor (e.g., a traditional desktop computer, a laptop computer, a cellular telephone with computing capabilities, a server, etc.) or a group of devices (or processing power) or systems distributed across a network. Once the request is directed to the victim (106), the requesting source(s) (108, 110, 112, 114) awaits the processing of the request and the arrival of the resulting response.

Requests and responses are sent across one or more networks via routers. The routers (116, 118) are capable of receiving network traffic (i.e., a packet) from one location (e.g., requesting source 1 (108)) and directing the network traffic to another location (e.g., victim (106)). Routers (e.g., router 1 (116)) are capable of receiving network traffic from multiple requesting sources (e.g., 108, 110, 112).

A router (116, 118) in accordance with an embodiment of the invention contains logic to recognize a conversation between a given source (e.g., Requesting Source 1 (108)) and a given destination (e.g., Replica 1 (120)). Additionally, a router (116, 118), in accordance with an embodiment of the invention, is capable of adding a header to an intercepted packet to ensure that it arrives at an intended destination. Similarly, the router (116, 118) contains logic to remove a header from a packet to ensure that the packet is properly received by the intended destination. In other words, a router in accordance with an embodiment of the invention includes functionality to add/remove headers to/from a packet it receives in order to properly forward a packet to a chosen destination. One skilled in the art will appreciate that the router (116, 118) need not be a hardware device as is commonly understood in the art. For example, the router (116, 118) may be a computer in the path between the requesting source (108, 110, 112, 114) and the victim (106).

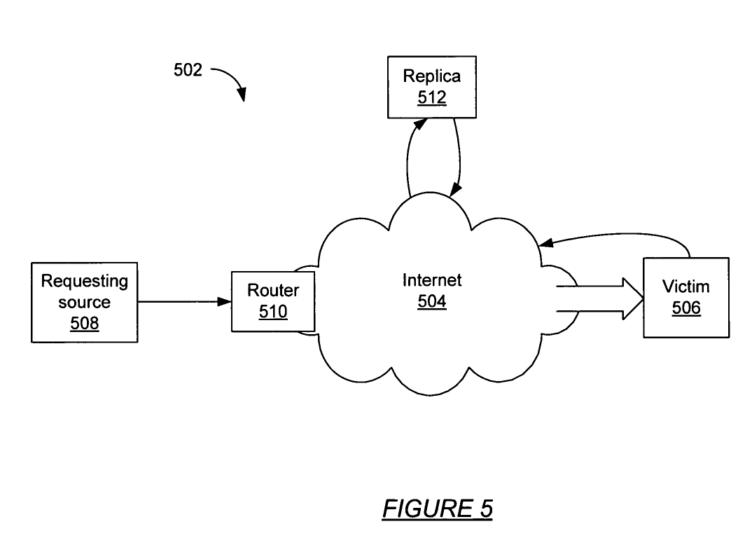

The victim (106) may be any computing device or system that receives requests (i.e., request packets) via the WAN (104) and, in return, has the capacity to send responses (i.e., response packets) therefrom. For example, the victim (106) may be a server for a web page on the Internet. In the case where the victim is a server for a web page, the requests sent from the requesting source(s) (108, 110, 112, 114) may be packets (similar to those described and shown in FIGS. 5A and 5B below) sent through a router (e.g., Router 1 (116)) to the victim (106) via the Internet. In one embodiment of the invention, these packets are sent using Transport Control Protocol/Internet Protocol (TCP/IP), so the packets should conform to the IP standards. While IP packets are discussed in this disclosure, one skilled in the art will appreciate that any transfer protocol may be used, such as TCP, UDP, HTTP, etc.

In one embodiment of the invention, the victim (116) is configured to identify the source(s) of the request(s) that it receives. For example, if Requesting Source 1 (108) directs an IP packet to victim (106), victim (106) is capable of recognizing that Requesting Source 1 (108) is the source of the packet.

In one embodiment of the invention, the victim (106) is further configured to locate any number of routers (e.g., Router 1 (116), Router N (118)) between the requesting source(s) (108, 110, 112, 114) and the victim (106), as well as to locate or generate one or more replica(s) (120, 122, 124). Continuing with the example, if the victim (106) determines that the Requesting Source 1 (108) has sent a request, the victim (106) may further determine that Router 1 (116) is located between Requesting Source 1 (108) and the victim (106).

As discussed above, a replica may be located or generated by victim (106). Given appropriate circumstances, such as becoming overburdened with network traffic, the victim (106) may issue one or more requests to other systems to emulate the functionality of the victim (106). In another instance, a replica may be created at a particular time of day. In other words, a replica (120, 122, 124) of the victim (106) is generated on another system by request of the victim (106). The victim (106) then communicates with the other system to set up a “mirror” system with functionality identical to that of the victim (106). In some instances, a replica (e.g., replica 1 (120)) may already exist, and the victim simply issues a request for the replica to become active. One skilled in the art will appreciate that while the victim (106) has been described above as locating or generating a replica (120, 122, 124), a router (e.g., router 1 (116)) may also contain such functionality.

The replica (120, 122, 124) is designed to emulate the functionality of the victim (106). The replica may be any network device capable of performing this function. For example, when the victim (106) is a server for a web site on the Internet, the replica (120, 122, 124) may be a server designed to imitate the functionality of the victim in a manner that is not detectable by a requesting source. The replica (120, 122, 124) may be directly connected to the router (i.e., not connected through a network connection). Further, in one embodiment of the invention, the replica (120, 122, 124) is a process on the router.

One skilled in the art will appreciate that the replica(s) (120, 122, 124) needs not be directly associated with the victim (106). For example, in one embodiment of the invention, one or more replicas (120, 122, 124) are in a different domain than the victim (106). In another embodiment of the invention, one or more replicas (120, 122, 124) are in the same domain (e.g., domain (130) in FIG. 1) as the victim (106).

While the victim (106) has been described with particular functionality such as, e.g., identifying a source of requests and determining addresses of replicas, one skilled in the art will appreciate that such functionality could also be associated with other components of network system, such as the router (116, 118). For example, Router 1 (116) may be configured to identify the source(s) of request(s) sent from the requesting source (108, 110, 112, 114) and directed to the victim (106). Similarly, Router 1 (116) may locate replicas (e.g., 120, 122, 124) of the victim (106) connected to the WAN (104).

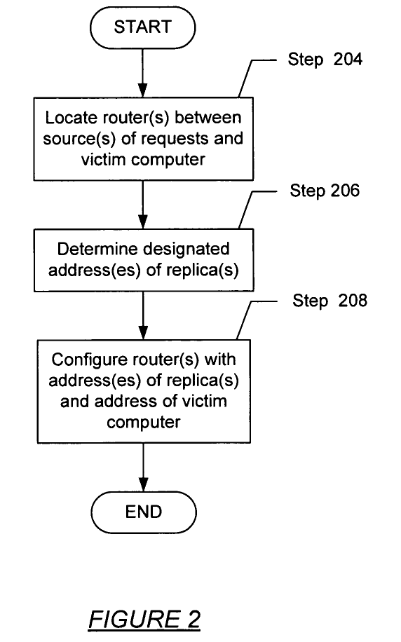

FIG. 2 shows a flowchart depicting a technique for informing a router of elements in a network system in accordance with an embodiment of the invention. Beginning with Step 204, one or more routers in accordance with an embodiment of the invention are identified. In one embodiment of the invention, the router(s) are between the source(s) of at least some of the requests and the victim. Further, in one embodiment of the invention, the victim performs a search for routers meeting the criteria of being between itself and the requesting source(s). Then, one or more addresses of one or more replicas are determined (Step 206). Determining the address(es) of the replica(s) includes first creating or locating the replica(s).

The victim may create replicas to emulate the functionally of the victim based a predetermined list of requirements or based on the current requirements of the victim. Once created, addresses (i.e., an IP address) are associated with the replicas. Alternatively, replicas may be located by the victim or by a router associated with the victim. For example, if the victim becomes overloaded with request packets from a large number of requesting sources, the victim may create (or search for) replicas that can emulate the functionality of the victim. The victim may have a predetermined list of requirements necessary for replicas and a hierarchical order that it uses to request the replicas. The replicas may be located in diverse locations. In one embodiment of the invention, one or more replicas are located near at least some of the requesting sources.

After the address(es) of the replica(s) is determined, one or more routers in accordance with an embodiment of the invention (e.g., that were found between the requesting sources and the victim in Step 204) are configured with one or more addresses of one or more replicas, as well as the address of the victim associated with the replica(s) (Step 208). In one embodiment of the invention, the set of replicas configured into a given router are chosen to be near that router.

One skilled in the art will appreciate that any number of criteria may be used to determine when a replica should be created, and how much traffic should be diverted to each replica. For example, a router may test response times to the victim, and to each replica, in order to estimate what share of requests the router diverts to each replica. In one embodiment of the invention, the victim may explicitly request assistance in handling a large number of request packets from a large number of requesting sources. In another embodiment of the invention, a router may probe the victim to estimate a response time of the victim. If the victim does not respond within a specified time, the router may establish a connection to a replica. In other embodiments of the invention, heuristics such as a volume of traffic directed to the victim or the time of day may be used to determine that replicas are necessary.

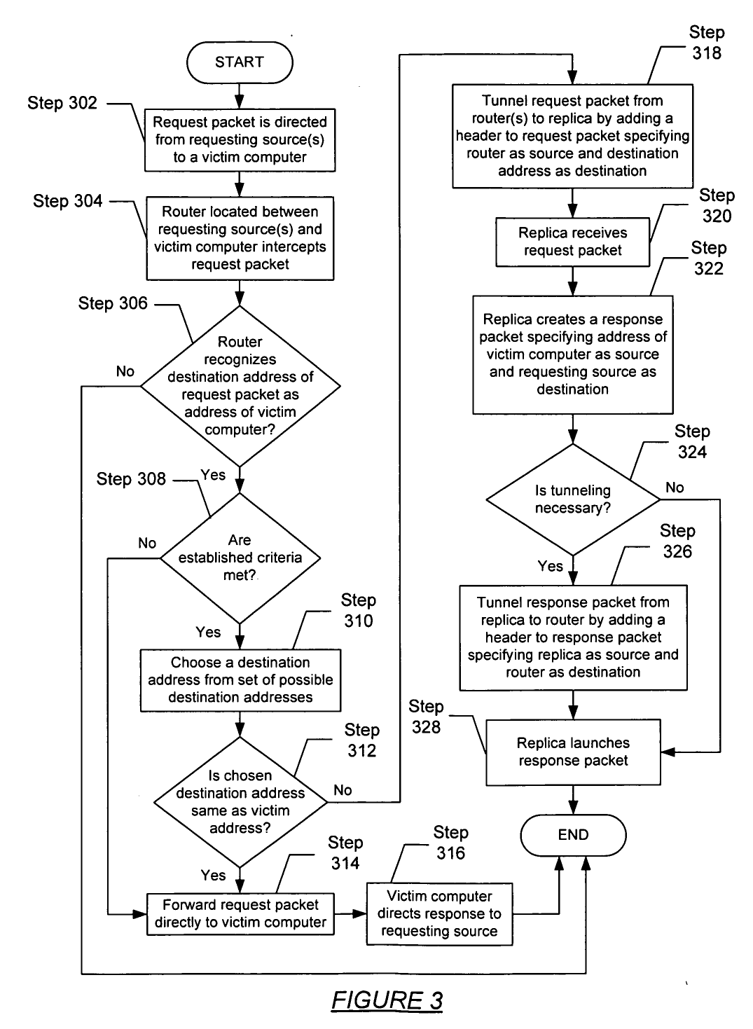

If it has been established that a victim requires assistance from one or more replicas to handle requests from requesting sources, a number of the requests that may have been sent to the victim must be appropriately directed to the victim or to the replicas. FIG. 3 depicts a method for routing one or more network packets in accordance with an embodiment of the invention.

In FIG. 3, a request packet is directed from a requesting source to a victim (Step 302). Under normal conditions (i.e., when replicas are not necessary for a victim), this request packet would be sent to the victim in a manner well known to one skilled in the art.

However, when it has been determined that one or more replicas may be necessary, a router, which has been informed of the address(es) of the replica(s) and the associated victim and is located between the requesting source and the victim, intercepts the request packet (Step 304). If the router does not recognize the destination address of the request packet as the address of the victim (Step 306), the process ends, and the request packet is forwarded to the appropriate location. If the router does recognize the destination address of the request packet as the address of the victim (Step 306), then a determination is made whether established criteria are met to use the replica(s) (Step 308). For example, as discussed above in relation to FIG. 1, the router may determine whether it is an appropriate time of day or network traffic level to use a replica. Alternatively, the router may determine that due to the proximity of the requesting source to the victim or the activity level of the victim, it is most appropriate to forward the request packet directly to the victim.

If the established criteria are met (Step 308), a destination address is chosen from the set of possible destination addresses (Step 310). At this point, the set of possible destination address(es) have already been determined in a manner as described above in relation to Step 206 of FIG. 2. In one embodiment of the invention, the set of possible destination addresses includes the IP address of the victim and the IP address(es) of at least one replica computer. Further, in one embodiment of the invention, the set of possible destination addresses may be adjusted based on the status of the network and, specifically, the victim. For example, the number of destination addresses in the set may increase/decrease based on the level of the attack on the victim, including the exact type(s) of replica(s) needed to handle a specific request (i.e., similar network traffic is sent to the same replica), etc.

A destination address may be chosen from the set of destination addresses based on a number of criteria. For example, similar traffic may always be routed to a given machine. In other instances, a packet may be routed based on the location of the network device closest to the router that advances a packet toward an intended destination. Alternatively, the packet may be routed to a network device that the router knows is near the intended destination. In one embodiment of the invention, the router may hash information from the packet it receives to determine where to forward the packet.

Continuing with FIG. 3, if a determination is made that the destination address chosen is the same as the address of the victim (Step 312), the request packet is forwarded directly to the victim (Step 314). The victim then creates a response and directs the response to the requesting source (Step 316).

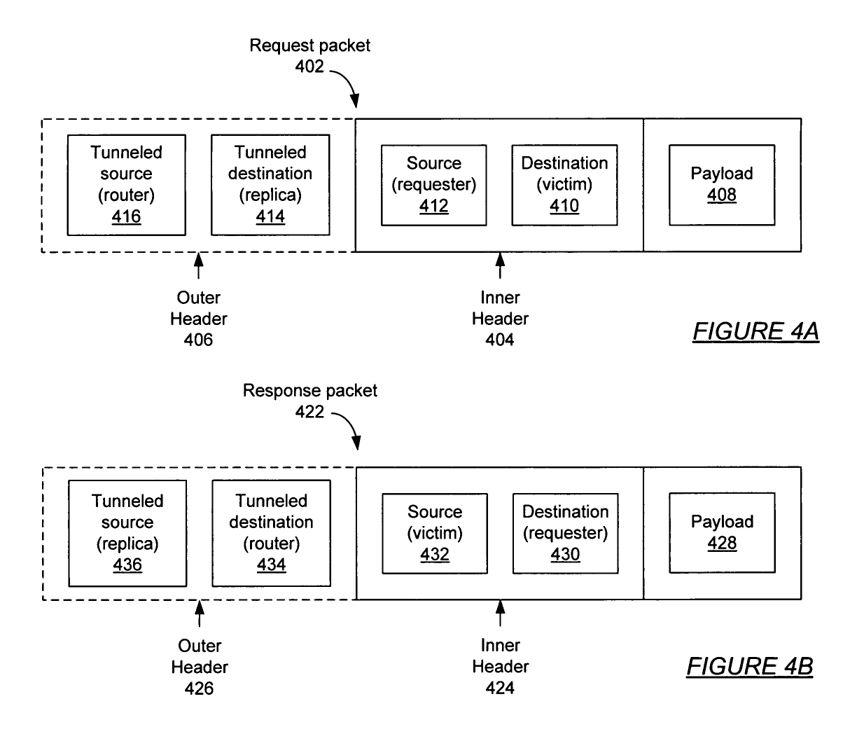

If a determination is made that the destination address chosen is not the same as the address of the victim (i.e., the destination address is the address of a replica) (Step 312), the request packet is tunneled from the router to the replica with the chosen destination address (Step 318). In one embodiment of the invention, tunneling is accomplished by adding a header to the request packet that specifies the router as a tunneled request source and the destination address of the chosen replica as a tunneled request destination. An example of a request packet used to tunnel is shown in FIG. 4A.

FIG. 4A shows a request packet (402) in accordance with one embodiment of the invention. The request packet (402) includes a payload (408), an inner header (404), and an outer header (406). The payload (408) contains data intended to be transmitted from a source (e.g., Requesting Source 1 (108) shown in FIG. 1) to a destination (e.g., victim (106) shown in FIG. 1). The inner header (404) includes a source (412) and a destination (410), while the outer header (406) includes a tunneled source (416) and a tunneled destination (414). In this embodiment, the source (412) is a requesting source (e.g., requesting source 1 (108) shown in FIG. 1), the destination (410) is a victim (e.g., victim (106) shown in FIG. 1), the tunneled source (416) is a router (e.g., Router 1 (116) shown in FIG. 1), and the tunneled destination (414) is a network component at a diverted location (e.g., Replica 1 (120) shown in FIG. 1).

Returning to FIG. 3, the tunneled request packet is forwarded to the replica, which receives the tunneled request packet, directly or indirectly, from the router (Step 320). In response to the request packet, the replica creates a response packet, specifying the address of the victim as the source and the requesting source as the destination (step 322).

In some cases, the replica replies directly to the requesting source by using the victim's address as the source of the packet, and the requesting source's address as the destination of the packet. However, this may not always be possible. For example, if a router on the path between the replica and the requesting source performs source address filtering, packets may be discarded if the source address arrives from an unexpected direction. In some cases, for instance, when the replica is in the same domain as the router, the requesting source, or the victim, or if it is known that no routers on the path between the replica and the requesting source are doing source address filtering, tunneling is not necessary, and the packet may be sent directly from the replica to the requesting source without tunneling.

In one embodiment of the invention, the replica is configured with a set of address pairs (e.g., the router that diverted the request packet and the requesting source) for which the replica need not perform tunneling. If tunneling is not necessary (e.g., the replica determines that the replica is in the same domain as the victim (Step 324)), then the replica launches the response packet (Step 328). In one embodiment of the invention, the replica directs the response packet through the router to the requesting source. However, if tunneling is necessary (e.g., if the replica is not in the same domain as the victim), the replica first creates a tunneled response packet from the replica to the router by adding a header to the response packet that specifies the replica as the tunneled response source and the router as the tunneled response destination (Step 326). In other words, the response packet is encapsulated in the outer header. An example of a response packet used to tunnel is shown in FIG. 4B.

FIG. 4B shows a response packet (422) in accordance with one embodiment of the invention. The response packet (422) includes a payload (428), an inner header (424), and an outer header (426). The payload (428) contains data intended to be transmitted from a source (e.g., victim (106) shown in FIG. 1) to a destination (e.g., Requesting Source 1 (108) shown in FIG. 1). The inner header includes a source (432) and a destination (430), while the outer header (426) includes a tunneled source (436) and a tunneled destination (434). In this embodiment, the source (432) is a victim (e.g., victim (106) shown in FIG. 1), the destination (430) is a requesting source (e.g., Requesting Source 1 (108) shown in FIG. 1), the tunneled source (436) is a network component at a diverted location (e.g., Replica 1 (120) shown in FIG. 1), and the tunneled destination (434) is a router (e.g., Router 1 (116) shown in FIG. 1).

Returning to FIG. 3, the replica then directs the response packet through the router to the requesting source (Step 238), and the process ends. One skilled in the art will appreciate that router strips the tunneled header from the tunneled response packet in the event that the replica tunneled the response and directed it to that router.

One skilled in the art will appreciate that other components of a packet may be included depending on the implementation of the packet. For example, a system (e.g., TCP/IP) may include a trailer, which includes components to ensure that errors do not occur during transmission of the packet.

FIG. 5 shows an example of a network system (502) in accordance with an embodiment of the invention. In FIG. 5, a requesting source (508) is connected via a router (510) to the Internet (504). A victim (506) and a replica (512) are also connected to the Internet (504). Similar to the network system (102) shown in FIG. 1, the router (510) is on a path between the requesting source (508) and both the victim (506) and the replica (512).

One skilled in the art will appreciate that addresses of devices that access the Internet typically use IPv4 addresses, which are 32-bit numeric addresses. However, one skilled in the art will appreciate that other address formats are possible, such as IPv6, which uses 128-bit addresses. The typical representation of an IPv4 address is four positive integers separated by periods (e.g., 192.138.57.27). For the purpose of illustrating this exemplary embodiment of the invention, IP addresses will simply be referred to by a single number (e.g., 27). One skilled in the art will appreciate that the use of such a single number to represent an IP address is not meant to restrict the format or size of an address in a packet.

In FIG. 5, the requesting source (508) sends a request packet directed to victim (506), at address 92. This packet is intercepted by the router (510). Router (510) has a set of n (in this example, n=2) addresses including 92, which represents the victim (506), and 27, which represents a replica (512).

Upon intercepting the request packet, the router (510) makes a determination to send the packet to replica (512). Accordingly, replica (512) chooses address 27 and tunnels the request packet to replica (512) by adding the appropriate IP header to the packet which specifies the address 27 of the replica (512) as the destination, and the address of the router (510) as the source. One skilled in the art will appreciate that a number of solutions exist to ensure that packets from a given “conversation” (i.e., an exchange of related request and response packets between a given request source and a victim or replica) always go to the same replica. For example, as described in the embodiment of the invention shown in FIG. 5, the router (510) hashes the source and destination addresses as well as the layer 4 ports of the request packet. The result, modulo 2, (there are 2 choices of addresses for the router (510) to choose) determines the destination address that the router (510) uses to forward the request packet.

When the replica (512) receives the request packet, a response packet is created in the same manner as a response packet created by the victim (506). In other words, the response packet created by the replica (512) is identical to a response packet that would be created by the victim (506). However, because the replica (512) recognizes that tunneling is necessary, the replica (512) adds a response header to the response packet in order to properly tunnel the response packet to the requesting source (508). In other words, an outer header is added to the response packet such that the address of the router (510) is specified as the tunneled destination, and the address of the replica (512) is specified as the tunneled source. Accordingly, when the router (510) receives the tunneled response packet, the router strips the outer header from the tunneled response packet, and forwards the response packet (without the outer header added by the replica (512)) to the requesting source (508).

One skilled in the art will appreciate that whenever a request packet intended for a victim is diverted to a replica, the load of that particular victim is decreased. Further, one skilled in the art will appreciate that a router does not need to be configured between a victim and all request sources; nor do all packets from requesting sources need to be routed to replicas. Further, one skilled in the art will appreciate that a router may be configured that is not in the path between a particular request source and a particular victim.

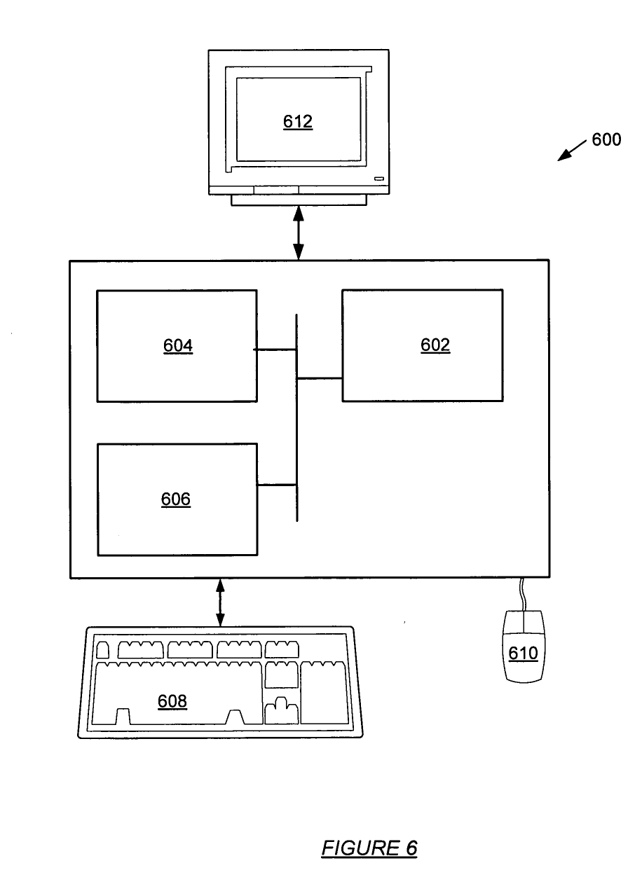

The invention may be implemented on virtually any type of computer regardless of the platform being used. For example, as shown in FIG. 6, a computer system (600) includes a processor (602), associated memory (604), a storage device (606), and numerous other elements and functionalities typical of today's computers (not shown). The computer (600) may also include input means, such as a keyboard (608) and a mouse (610), and output means, such as a monitor (612). The computer system (600) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (600) may be located at a remote location and connected to the other elements over a network. Further, the invention may be implemented on a distributed system having a plurality of nodes, where each portion of the invention (e.g., router, victim, replica, requesting source, etc.) may be located on a different node within the distributed system. In one embodiment of the invention, the node corresponds to a computer system. Alternatively, the node may correspond to a processor with associated physical memory. Further, software instructions to perform embodiments of the invention may be stored on a computer readable medium such as a compact disc (CD), a diskette, a tape, a file, or any other computer readable storage device.

Embodiments of the invention have one or more of the following advantages. Embodiments of the invention allow a network component (i.e., a victim) to be protected from a large gain in traffic (i.e., an increased number of requests) in a manner that is transparent to any requesting source, as well as to a human user. Additionally, in one embodiment of the invention, the content of a domain name server does not need to be changed, which allows for a quick avoidance of an overload of a victim without assistance from an outside organization. Further, one skilled in the art will appreciate that embodiments of the invention may support SSL sessions, as a private key may be shared between a victim and a replica. Further, embodiments of the invention allow replicas (with varying network addresses) that appear identical to a victim to be distributed anywhere in a network (i.e., without being restricted to a particular location). In other words, a router may forward a packet from a requesting source to any replica located anywhere on a network, while maintaining an appearance of a single victim to the requesting source.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for protecting a victim, comprising:
locating at least one router;
providing a set of addresses associated with at least one replica and a victim to each of the at least one router;
intercepting a request packet sent from a requesting source to the victim by one of the at least one router;
directing the request packet to the at least one replica; and
creating a response packet specifying the victim as a response source and the requesting source as a response destination.

2. The method of claim 1, wherein directing the request packet to the at least one replica comprises adding a request header to the request packet specifying an address of the one of the at least one router as a tunneled request source and an address of one of the at least one replica as a tunneled request destination.

3. The method of claim 1, further comprising:
receiving the request packet at the one of the at least one replica.

4. The method of claim 1, further comprising:
sending the response packet through at least one router to the requesting source.

5. The method of claim 4, further comprising:
adding a response header to the response packet specifying the address of the one of the at least one replica as a tunneled response source and the address of one of the at least one router as a tunneled response destination.

6. The method of claim 5, wherein the one of the at least one replica is in a different domain than the victim.

7. The method of claim 5, further comprising:
removing the response header from the response packet prior to arriving at the requesting source.

8. The method of claim 5, wherein the response packet comprises:
a payload for the requesting source;
a destination specifying an address of the requesting source; and
a source specifying an address of the victim requested by the requesting source.

9. The method of claim 8, wherein the response packet is encapsulated in an outer header, comprising:
the tunneled response source specifying the address of the one of the at least one replica; and
the tunneled response destination specifying the address from which the request packet was received by the at least one replica.

10. The method of claim 1, wherein the request packet comprises:
an inner header, comprising:
a payload for the victim;
a destination specifying an address of the victim; and
a source specifying an address of the requesting source sending the request packet; and
an outer header, comprising:
the tunneled request destination specifying the address of the one of the at least one replica; and
the tunneled request source specifying the address of one of the at least one router in the path between the requesting source and the replica.

11. The method of claim 1, further comprising:
estimating a response time of the victim and at least one replica.

12. The method of claim 1, further comprising:
adding the request header to the request packet when established criteria are met, wherein established criteria comprises at least one selected from the group consisting of whether a volume of traffic is above an established threshold, a volume of network traffic, a response time of the victim, and a time the request packet is sent.

13. The method of claim 1, further comprising:
creating at least one replica in response to established criteria.

14. The method of claim 1, further comprising:
choosing to send the request packet to at least one replica in response to established criteria.

15. The method of claim 14, wherein the request packet associated a same conversation is directed to the same replica of the at least one replica.

16. A network system, comprising:
at least one requesting source configured to send a request packet to a victim;
at least one router; and
at least one replica associated with the victim, wherein the at least one replica is configured to receive the request packet and to redirect the request packet sent from the at least one requesting source intended for the victim,
wherein the at least one router is configured to direct the request packet to the at least one replica.

17. The network system of claim 16, wherein directing the request packet to the at least one replica comprises adding a request header to the request packet specifying an address of the one of the at least one router as a tunneled request source and an address of one of the at least one replica as a tunneled request destination.

18. The network system of claim 16, wherein the at least one replica is further configured to add a response header to the response packet specifying the address of the one of the at least one replica as a tunneled response source and the address of the one of the at least one router as a tunneled response destination.

19. The network system of claim 18, wherein the at least one replica is further configured to send the response packet to the at least one requesting source through the at least one router.

20. The network system of claim 18, wherein the response packet comprises:
an inner header, comprising:
a payload for the requesting source;
a destination specifying an address of the requesting source; and
a source specifying an address of the victim requested by the requesting source.

21. The network system of claim 20, wherein the response packet is encapsulated in an outer header, comprising:
the tunneled response source specifying the address of the one of the at least one replica; and
the tunneled response destination specifying the address from which the request packet was received by the at least one replica.

22. The network system of claim 16, wherein the victim is further configured to create at least one replica in response to established criteria.

23. The network system of claim 16, wherein the at least one router is further configured to send the request packet to at least one replica in response to established criteria.

24. The network system of claim 23, the at least one router is further configured to send the request packet associated a same conversation is directed to the same replica of the at least one replica.

25. The network system of claim 16, wherein the request packet comprises:
an inner header, comprising:
a payload for the victim;
a destination specifying an address of the victim; and
a source specifying an address of the requesting source sending the request packet; and
an outer header, comprising:
the tunneled request destination specifying the address of the at least one replica; and
the tunneled request source specifying the address of the at least one router in the path between the requesting source and the replica.

26. The network system of claim 16, wherein the at least one replica is in a different domain than the victim.

27. A computer system for protecting a victim comprising:
a processor;
a memory;
a storage device; and
software instructions stored in the memory for enabling the computer system under control of the processor to:
locate at least one router on a path between the victim and a requesting source;
provide a set of addresses associated with at least one replica and the victim to each of the at least one router;
intercept a request packet sent from the requesting source to the victim by one of the at least one router;
direct the request packet to the at least one replica; and
create a response packet specifying the victim as a response source and the requesting source as a response destination.
